(19) United States
(12) Patent Application Publication
(10) Pub. No.: US 2020/0015492 A1
(43) Pub. Date: Jan. 16, 2020

(54) METHODS OF MAKING NON-DAIRY MILK AND SYSTEMS ASSOCIATED THEREWITH

(71) Applicant: Lyrical Foods, Inc., Hayward, CA (US)

(72) Inventors: Audrey C. Ku, Hayward, CA (US); Pamela Quok, Hayward, CA (US); Forest Walter Marchese, Hayward, CA (US); Monte Casino, Hayward, CA (US); Michael Allen Boals, Hayward, CA (US)

(21) Appl. No.: 16/509,384

(22) Filed: Jul. 11, 2019

Related U.S. Application Data
(60) Provisional application No. 62/696,720, filed on Jul. 11, 2018.

(51) Int. Cl. A23C 11/10

(52) U.S. Cl. CPC A23C 11/103

(57) ABSTRACT

Methods of making non-dairy milk generally include decompounding solid material in a slurry of liquid and nut and/or seed material followed by milling the slurry in a shearmill. After the decompounding step, the slurry includes insoluble solids, and the slurry subjected to milling includes substantially all of the insoluble solids. No intervening separation, filtration or similar steps are performed on the slurry between the decompounding and milling steps, thereby improving the yield and economics of the methods. Related systems for carrying out the method are also described.

### CROSS-REFERENCE TO RELATED APPLICATION(S)

The present application claims priority under 35 U.S.C. § 119(e) to U.S. Provisional Patent Application No. 62/696,720, filed Jul. 11, 2018, the entirety of which is hereby incorporated by reference.

### TECHNICAL FIELD

This disclosure relates to consumables, foodstuff, and related technologies, including related methods of manufacture. In particular, the disclosure relates to methods of making non-dairy milk, and related technologies, such as systems configured for making non-dairy milk in accordance with the methods described herein.

### BACKGROUND

Non-dairy milk has grown in popularity in recent years. Non-dairy milk may include plant-derived milk made from nuts, seeds, or both. Exemplary nut-based non-dairy milk includes almond milk, chestnut milk, pecan milk, hazelnut milk, cashew milk, pine nut milk, and walnut milk.

In the manufacture of non-dairy milk, such as the nut-based non-dairy milks mentioned above, the process generally includes one or more nut conditioning steps. Nut conditioning steps can include one or more of washing, sterilizing, blanching, hydrating, drying, and decompounding. With respect to decompounding, this generally involves grinding, milling, blending, crushing, tumbling, crumbling, atomizing, shaving, chopping, and/or pulverizing the nuts and/or nut fragments so that smaller pieces of the nuts are provided.

Once decompounded, the nut pieces may be subjected to further processing to form non-dairy milk. As described in U.S. Pat. No. 9,011,949, a step of separating insoluble solids from a slurry including the decompounded nuts may be carried out. As discussed in the '949 patent, this step of separating insoluble solids is carried out because the presence of insoluble solids in the non-dairy milk was believed to hinder the formation of curds in the non-dairy milk, thereby making the non-dairy milk unsuitable for use in making cheese, yogurt, and the like. The presence of insoluble solids was also believed to negatively impact the mouthfeel of the non-dairy milk and products formed therefrom. In order to remove the insoluble solids, the '949 patent describes the use of a decanter centrifuge or the like in order to remove at least 50% and up to 99% of the insoluble solids from the slurry formed after decompounding.

One problem with the separation of insoluble solids from the slurry is that valuable and beneficial solids material is removed from the slurry as a result of the separation process. In some cases where separation of insoluble solids is carried out, it has been found that 10 to 20% or more of the solid material is removed from the slurry and eliminated as waste. The solids material removed from the slurry and which therefore does not end up in the final non-dairy milk product may include soluble fiber and/or insoluble fiber, as well as functional components, such as proteins and fats. The solids material removed from the slurry can also contain protein and fat. All of these components are considered desirable components of the non-dairy milk product. Accordingly, while separation methods such as those discussed in the '949 patent may provide some benefits, the separation methods also negatively impact the economics of the overall production method by removing and treating as waste valuable material that might otherwise improve the yield of the process and/or quality of the non-dairy milk.

Accordingly, a need exists for a method of making non-dairy milk that reduces waste, improves yield and product quality, and retains the functionality and functional components of milk while still addressing issues of mouthfeel and impeding curd formation.

### BRIEF DESCRIPTION OF THE DRAWINGS

FIG. 1A is a flow chart illustrating a method for making non-dairy milk in accordance with various embodiments described herein.

FIG. 1B is a flow chart illustrating a method for making non-dairy milk in accordance with various embodiments described herein.

FIG. 2A is a block diagram illustrating a system for making non-dairy milk in accordance with various embodiments described herein.

FIG. 2B is a block diagram illustrating a system for making non-dairy milk in accordance with various embodiments described herein.

FIG. 3 is a flow chart illustrating a method for producing non-dairy yogurt in accordance with various embodiments described herein.

FIG. 4 is a flow chart illustrating a method for producing a cheese replica in accordance with various embodiments described herein.

FIG. 5 is a flow chart illustrating another method for producing a cheese replica in accordance with various embodiments described herein.

FIG. 6 is a graph illustrating various particle size distributions for non-dairy milks produced from methods in accordance with embodiments described herein.

### DETAILED DESCRIPTION

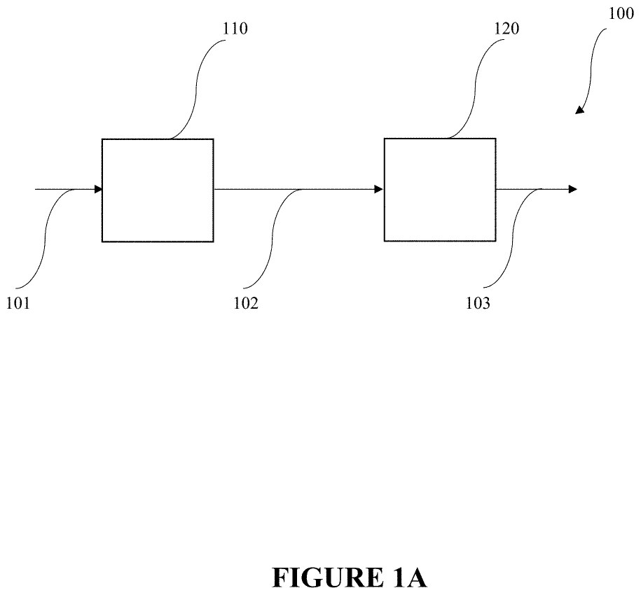

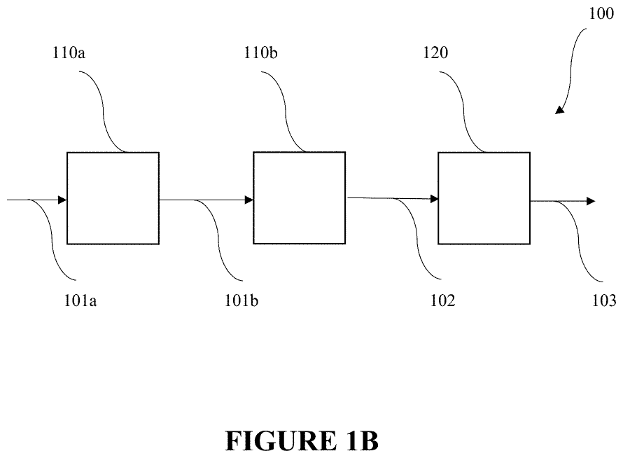

With reference to FIG. 1A, a method 100 of making non-dairy milk includes a step 110 of decompounding the solid material present in a slurry 101 subjected to decompounding step 110, and a step 120 of milling the decompounded slurry 102. The solid material included in the slurry 101 will generally include nuts and/or seeds (and/or fragments thereof) that form the basis for the non-dairy milk. The decompounding step 110 is generally aimed at reducing the size of the solid nut and/or seed material included in the slurry 101. The slurry 102 produced by decompounding step 110 generally includes an insoluble solid content. In step 120, further reduction in the size of the solid material in the decompounded slurry 102 is carried out via milling. The milling can be carried out using a shearmill. The slurry 102 subjected to the milling in step 120 includes substantially all of the insoluble solid content present in the slurry 102 at the end of the decompounding step 110. A non-dairy milk precursor 103 is produced from step 120, which can then be subjected to further processing steps, such as pasteurization, to complete the method of making non-dairy milk.

Slurry 101 generally includes nuts, seeds, legumes or a combination thereof (including fragments thereof) mixed together with a liquid such as water to form a slurry. The ratio of nuts and/or seeds to liquid can be selected based on the desired characteristics of the non-dairy milk to be produced. The type of nut and/or seed used in slurry 101 is generally not limited. Exemplary nuts include, but are not limited to, almonds, cashews, chestnuts, and hazelnuts. Exemplary seeds include, but are not limited to, chia, flax, cereals, and gymnosperms. Exemplary legumes include, but are not limited to, peas, beans, chickpeas, lentils, and soybeans. The nuts and/or seeds in slurry 101 may be whole nuts and seeds, fragments of nuts and seeds, or a combination of both. Generally speaking, the size of the nuts and/or seeds (or fragments thereof) in slurry 101 require further reduction as part of the milk make process, and as such, the slurry 101 is subjected to decompounding step 110.

Decompounding step 110 generally involves the processing of the slurry such that the solid components of the slurry (e.g., nuts, seeds, fragments thereof, etc.) are reduced in size. Any specific manner of decompounding can be used in step 110, including, but not limited to, crushing, tumbling, crumbling, atomizing, shaving, grinding, and chopping. Any suitable equipment for carrying out any of these processes can also be used in step 110. In some embodiments, at least grinding is used in step 110. An exemplary grinder suitable for use in step 110 is an Urschel Comitrol® Processor 1500. The solid particle size reduction achieved in step 110 is generally not limited. That is, the decompounding can be carried out until any selected average particle size is achieved, provided that the solid material in the slurry 101 is reduced in size after step 110.

The decompounded slurry 102 produced from step 110 generally includes the liquid component present in slurry 101 and nuts and/or seed fragments reduced in size from slurry 101. By virtue of the decompounding, the slurry 102 can generally include components of the nuts and/or seeds, such as insoluble solids, soluble solids, fats, and proteins. In some embodiments, the insoluble solids and soluble solids include insoluble and soluble fibers.

In step 120, the slurry 102 is subjected to milling in order to further reduce the size of the solid particles in the slurry 102 (including soluble and insoluble solids). In some embodiments, step 120 is specifically a milling step carried out using a shearmill. Shearmills generally include a series of high-speed multi-aperture rotors turning close to a stationary element that grinds and/or mills feed material to reduce particle size in a continuous process. Other processing equipment that functions similarly to a shearmill can also be used. The aim of step 120 is to reduce the particle size of solids in the slurry 102 to within a targeted size range. Because no other size reduction generally takes place after step 120, the size of the particles is preferably reduced to a point where the non-dairy milk produced by the method 100 has a pleasing mouthfeel (i.e., is smooth and creamy and not grainy or pasty). In some embodiments, step 120 is carried out to reduce 90% of the solid particles in the slurry 102 to less than 70 microns. In some embodiments, step 120 reduces 90% of the solid particles in the slurry 102 to less than 60 microns. In some embodiments, step 120 reduces 50% of the particles in the slurry 102 to less than 10 microns. In some embodiments, step 120 reduces 50% of the particles in the slurry 102 to less than 7 microns. Step 120 reduces solid particles to within the desired size ranges without need for removing larger solid particles from the slurry 102.

As shown in FIG. 1A, the slurry 102 passes directly from the decompounding step 110 to the milling step 120. In other words, no intermediate processing of the slurry 102 is carried out between step 110 and 120. For example, no separation, filtration or other removal of material is performed on slurry 102. As such, the slurry 102 that is subjected to milling step 120 includes substantially all of the soluble solids and insoluble solids present in the slurry 102 immediate after the decompounding step 100. As used herein, substantially all means greater than about 99%. Thus, in some embodiments, substantially all (i.e., greater than 99%) of the insoluble solids in slurry 102 are in the slurry that is subjected to step 120.

The slurry 102 need not be subjected to step 120 immediately after step 110 from a timing perspective. That is to say, the slurry 102 may be held in a holding tank for any period of time between step 110 and 120, provided that no processing of the slurry 102 is carried out (e.g., no separation or removal of components of the slurry 102 is carried out between steps 110 and 120).

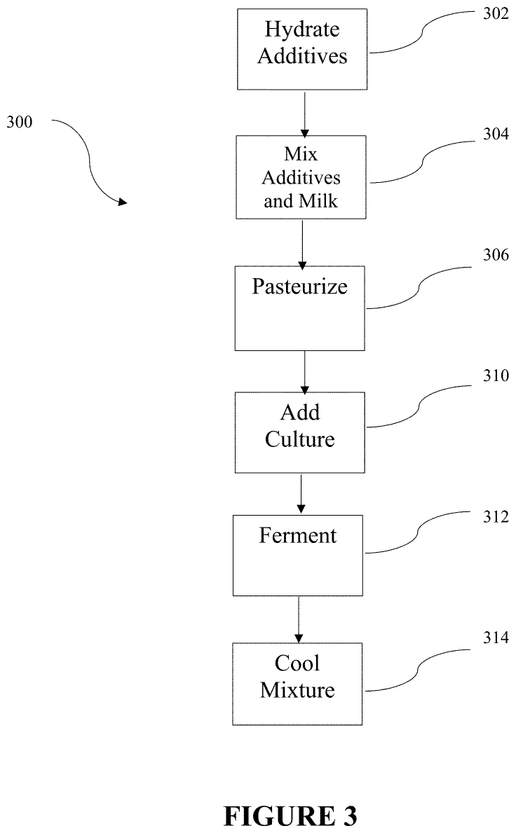

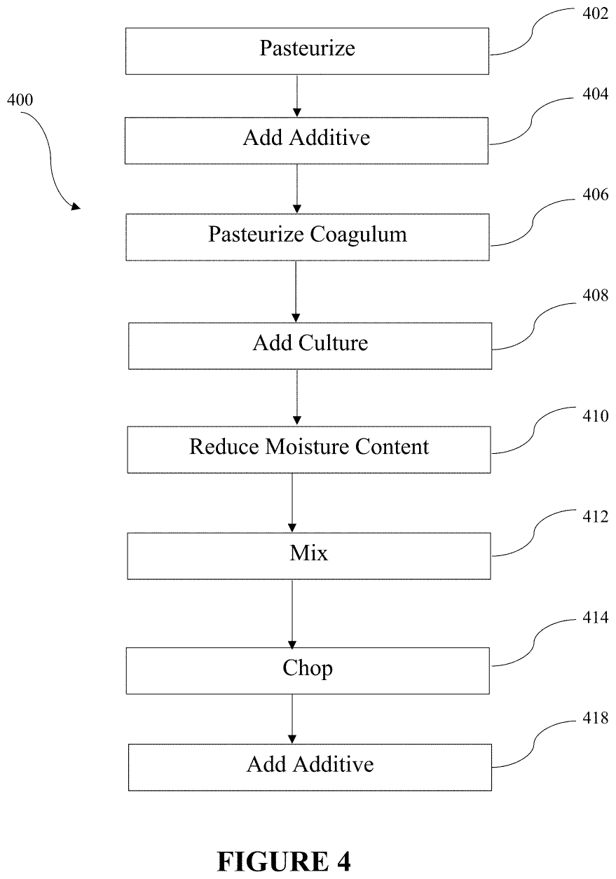

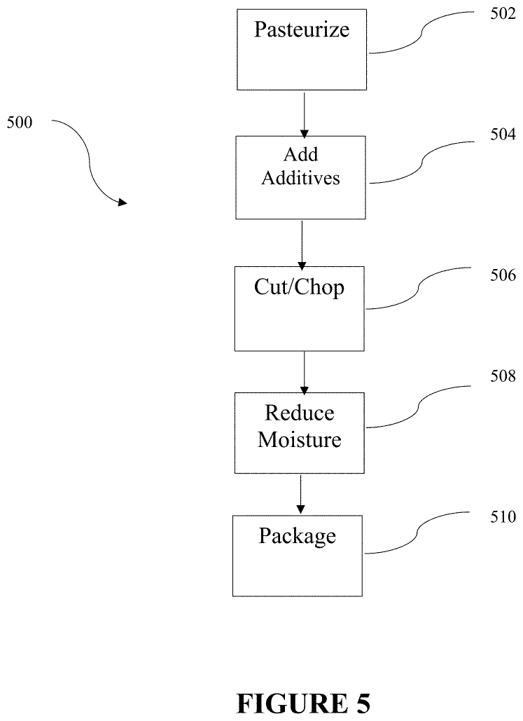

Non-dairy milk precursor 103 resulting from step 120 can be subjected to any further processing steps necessary for completing the milk making process. The milk precursor 103 can be collected in a holding tank to await further processing or may be subjected directly to further processing. Exemplary further processing that may take place includes pasteurization steps. The non-dairy milk produced by method 100 can be a consumable product, or can be used with the method for producing nondairy yogurt as discussed in connection with FIG. 3, cheese replicas as discussed in connection with FIGS. 4 and 5, or other consumable foodstuff.

With reference to FIG. 1B, an alternate embodiment for making non-dairy milk is illustrated. The method 100 of FIG. 1B is similar to the method 100 illustrated in FIG. 1A, but includes a two stage decompounding step. More specifically, slurry 101a (similar or identical to slurry 101 from FIG. 1A) is subjected to first decompounding step 110a, followed by slurry 101b being subjected to second decompounding step 110b. The two decompounding steps 110a, 110b are generally aimed at a step-wise reduction in the particle size of the solid material in the slurry 101a, 101b. For example, in decompounding step 110a, slurry 101a may be subjected to decompounding so that the solid material contained therein is reduced in size to a first average particle size, while in decompounding step 110b, slurry 101b may be subjected to decompounding so that the solid material contained therein is reduced in size to a second average particle size less than the first average particle size. As with FIG. 1A and decompounding step 110, any manner of carrying out the decompounding and any suitable equipment may be used in step 110a and 110b. In some embodiments, steps 110a and 110b are both grinding steps. An exemplary grinder that provides for two stage grinding as shown in FIG. 1B is an Urschel Comitrol® Processor 1500.

After step 110b, the method 100 illustrated in FIG. 1B may proceed in a similar or identical fashion to method 100 shown in FIG. 1A. More specifically, slurry 102 produced by step 110b, which will be similar or identical to slurry 102 from FIG. 1A, will proceed to step 120, where it is subjected to milling in a shearmill. As with FIG. 1A, the slurry 102 subjected to step 120 includes substantially all of the solid material (e.g., insoluble solids, soluble solids, etc.) contained in the slurry 102 immediately after completion of step 110b. The resulting non-dairy milk precursor 103 produced by step 120 is subjected to any required further processing for producing the non-dairy milk product (e.g., pasteurization).

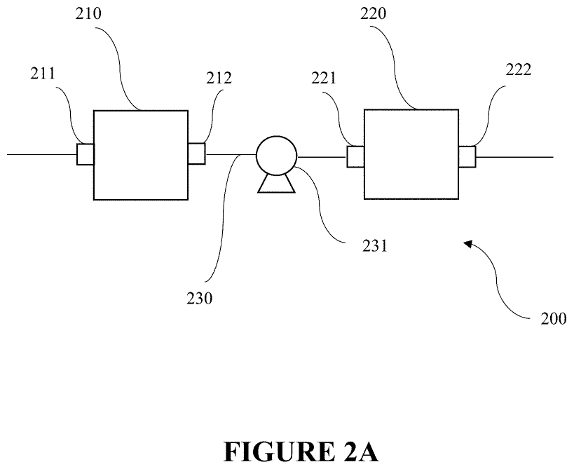

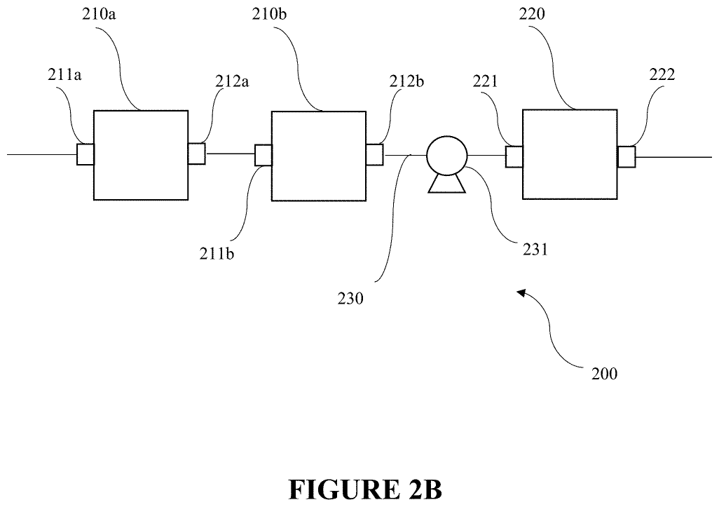

With reference to FIG. 2A, a system 200 for making non-dairy milk in accordance with various embodiments disclosed herein is illustrated. The system 200 generally includes a decompounding apparatus 210, a milling apparatus 220, and a conduit 230 configured to transport material from the decompounding apparatus 210 to the milling apparatus 220.

The decompounding apparatus 210 generally includes any device configured to reduce the size of the solid material contained in the slurry processed by the decompounding apparatus 210. As described previously, the slurry subjected to decompounding in the decompounding apparatus 220 will generally include a liquid, such as water, and nuts, seeds, fragments thereof, or a combination thereof. As such, the decompounding apparatus 210 generally operates to reduce the size of the nuts, seeds, nut fragments and/or seed fragments included in the slurry. Exemplary decompounding apparatus include, but are not limited to crushers, tumblers, crumblers, atomizers, shavers grinders, and choppers. In some embodiments, the decompounding apparatus 210 is a grinder. In some embodiments, the grinder is an Urschel Comitrol® Processor 1500.

Regardless of the specific equipment used, the decompounding apparatus 210 may generally include an inlet 211 and an outlet 212. Inlet 211 provides a means for introducing material (e.g., the slurry) into the decompounding apparatus 210 such that the decompounding apparatus 210 can decompound solid material contained in the material. Outlet 212 provides a means for the material to exit the decompounding apparatus 210.

The milling apparatus 220 generally includes any device configured to mill the slurry, and more specifically, reduce the size of solid material contained in the slurry processed by the milling apparatus 220. The slurry subjected to milling in the milling apparatus 220 is the slurry previously decompounded in the decompounding apparatus 210, and as such will include all of the same components as in the slurry introduced into the decompounding apparatus 210, with the exception that the particle size of the solid material (e.g., soluble solids, insoluble solids) will be smaller. The milling apparatus 220 operates to further reduce the size of the solid material included in the slurry. In some embodiments, the milling apparatus 220 is a shearmill, such as a Boston Shearmill 37-3 driven by Vacon X4 AC Drive.

As discussed in greater detail above with respect to FIG. 1A and milling step 120, the milling apparatus 220 is configured to reduce particle size of solid material in the slurry such that 90% of the solid particles have a particle size less than 70 microns or less than 65 microns. The milling apparatus 220 can also be configured to reduce particle size of solid material in the slurry such that 50% of the solid particles have a particle size less than 10 microns or less than 7 microns.

Regardless of the specific equipment used, the milling apparatus 220 may generally include an inlet 221 and an outlet 222. Inlet 221 provides a means for introducing material (e.g., the decompounded slurry) into the milling apparatus 220 such that the milling apparatus 220 can mill the slurry. Outlet 212 provides a means for the material to exit the milling apparatus 220.

Conduit 230 is provided for transporting material exiting the decompounding apparatus 210 to the milling apparatus 220. As such, the conduit 230 will generally have a first end in fluid communication with the outlet 212 of the decompounding apparatus 210 and a second end opposite the first end that is in fluid communication with the inlet 221 of the milling apparatus 220. Any suitable conduit can be used, such as piping of any suitable material, diameter, length, etc. In order to facilitate movement of material through the conduit 230, the system 200 can further include a positive displacement pump 231. In some embodiments, the positive displacement pump 231 is configured to move slurry material exiting the decompounding apparatus 210 via outlet 212, through the length of the conduit 230, to the inlet 221 of the milling apparatus 220.

In some embodiments, the system 200 is configured such that slurry exiting the decompounding apparatus 210 is transported directly to the milling apparatus 220. In other words, no intervening processing equipment, such as separation or filtration equipment, is provided between the decompounding apparatus 210 and milling apparatus 220. As a result, all components included in the slurry exiting the decompounding apparatus 210, including, e.g., insoluble and soluble solids, remain in the slurry that is fed into the milling apparatus 220.

With reference to FIG. 2B, a modification of the system 200 shown in FIG. 2A is illustrated, wherein the system 200 includes a two stage decompounding apparatus. Instead of a single decompounding apparatus 210 as shown in FIG. 2A, the system 200 includes a first decompounding apparatus 210a (including associated inlet 211a and outlet 212a) and a second decompounding apparatus 210b (including associated inlet 211b and outlet 212b). The first and second decompounding apparatus 210a, 210b are configured to perform step-wise reduction in the particle size of the solid material included in the slurry. As discussed in greater detail above with respect to FIG. 1B, the first decompounding apparatus 210a is configured to reduce particle size to a first average particle size and the second decompounding apparatus 210b is configured to reduce the particle size to a second average particles size that is smaller than the first average particle size. In some embodiments, both the first and second decompounding apparatus 210a, 210b are grinders. The Urschel Comitrol® Processor 1500 provides a two-stage grinder that is suitable for use in the system shown in FIG. 2B

The remainder of the system 200 shown in FIG. 2B is similar or identical to the system 200 shown in FIG. 2A. Following second decompounding apparatus 210b, the slurry is transported via conduit 230 (via assistance from positive displacement pump 231) to milling apparatus 220. Again, the system 200 can be configured such that slurry exiting the second decompounding apparatus 210b is transported directly to the milling apparatus 220 without any intervening processing equipment. In this manner, all components included slurry exiting the second decompounding apparatus 210b enter the milling apparatus 220.

While FIGS. 1B and 2B illustrate methods and system using two decompounding stages/apparatus, it should be appreciated that additional decompounding stages/apparatus can also be used, such as when there are three, four, five, etc., decompounding stages/apparatus.

In the methods illustrated in FIGS. 1A and 1B and the systems illustrated in FIGS. 2A and 2B, the slurry produced by the decompounding step includes soluble and insoluble solids (e.g., soluble fibers, insoluble fibers, etc.) as well as functional components such as fats and proteins. In some previously known milk make processes, insoluble solids are removed from the slurry prior to further processing such that the insoluble solids are permanently removed from the final milk product. In such process, about 10 to 20 wt % of the slurry produced from the decompounding step is separated from the slurry passed on for further processing in the milk make process. In contrast, the methods and systems described herein pass greater than 90 wt % of the slurry produced from the decompounding step to the milling step.

The systems 200 illustrated in FIGS. 2A and 2B can be used to produce, for example, almond milk, macadamia nut milk, cashew milk, or any other type of milk suitable for producing nondairy consumables/foodstuffs, such as nondairy yogurts, cheese, or the like. The non-dairy milk and consumables can be free of animal products, dairy ingredients, and other unwanted ingredients. Manufacturing byproducts can be limited or minimized to reduce waste and manufacturing costs.

FIG. 3 is a flow chart illustrating a method 300 for producing non-dairy yogurt using the non-dairy milk produced by methods described herein. At block 302, a sugar and stabilizer blend can be hydrated in water under high shear. At block 304, the hydrated sugar-stabilizer-water mixture can be combined with the non-dairy milk under agitation until mixed. At block 306, the mixture (e.g., yogurt mixture) can be pasteurized at about 180° F.-195° F. and cooled to inoculating temperature of about 108° F.-112° F. At block 310, a culture is added with gentle agitation until the culture is distributed. At block 312, a fermentation temperature of 108° F.-110° F. is maintained and the mixture is monitored (e.g., monitor pH for breaking). Fermentation can be stopped via agitation and cooling when one or more target characteristics (e.g., target pH 4.3-4.6) are reached. At block 314, the non-dairy yogurt is cooled (e.g., cooled to 40° F., 45° F., etc.) for flavoring, filling, or further processing.

The method 300 can be used to produce European-style yogurt, drinkable yogurt, or kid yogurt. The yogurt can include one or more of milk (e.g., almond milk, nut milk, seed milk, etc.), sugar, stabilizers, stabilizer blends, tricalcium phosphate, live active cultures, fruit, thickeners, colorants, flavors, herbs, spices, preservatives, stabilizers, plant-based proteins (for protein fortification), or the like. Tables 1-4 list exemplary ingredients.

TABLE 1
European-style Plain Yogurt (% values represent weight/weight)
Euro Plain

| Ingredient | Usage (%) |
|---|---|
| Plant-Based Solids | 7-15 |
| Plant-Based Fat | 6-10 |
| Plant-Based Protein | 1-3 |
| Sugar | 0-5 |
| Stabilizer Blend | <2 |
| Culture | <1 |
| Water | 65-90 |

TABLE 2
Greek Plain Yogurt (% values represent weight/weight)
Greek Plain

| Ingredient | Usage (%) |
|---|---|
| Plant-Based Solids | 17-25 |
| Plant-Based Fat | 6-10 |
| Plant-Based Protein | 6-9 |
| Sugar | 0-5 |
| Stabilizer Blend | ≤2 |
| Culture | ≤1 |
| Water | 48-70 |

TABLE 3
Drinkable Yogurt (% values represent weight/weight)
Drinkable Yogurt Plain

| Ingredient | Usage (%) |
|---|---|
| Plant-Based Solids | 4-12 |
| Plant-Based Fat | 1-4 |
| Plant-Based Protein | 2-5 |
| Tricalcium Phosphate | <1 |
| Stabilizer Blend | <1 |
| Vitamin Blend | <1 |
| Culture | <1 |
| Probiotic Culture | <1 |
| Water | 75-93 |

TABLE 4
Kids Tubes Yogurt (% values represent weight/weight)
Kids Tubes Plain

| Ingredient | Usage (%) |
|---|---|
| Plant-Based Solids | 10-18 |
| Plant-Based Fat | 5-9 |
| Protein | 3-6 |
| Cane Sugar | 0-7 |
| Stabilizer Blend | ≤3 |
| Culture | ≤1 |
| Water | 56-78 |

FIG. 4 is a flow chart illustrating a method 400 for producing a cheese replica in accordance with an embodiment of the disclosure. At block 402, milk is pasteurized at about 160° F.-195° F. and cooled to temperature of about 108° F.-112° F. At block 404, a culture and coagulating agent are mixed with gentle agitation and allowed to ferment to target pH. At block 406, a coagulum at pH 4.3-4.5 is produced, and the coagulum can be pasteurized at 148° F.-152° F. At block 408, the coagulum is cooled to 75° F. and repopulated with one or more cultures. At block 410, the curd can be pressed and to reduce the moisture content to a desired level (e.g., a moisture content of about 50-68% by weight or volume). At block 412, the curd can be transferred a mixer and mix evenly. At block 414, the curd can be provided to a chopper and chopped for a period of time (e.g., 1 minute, 2 minutes, 3 minutes, etc.). At block 418, water and lactic acid are added and then the mixture is further chopped until generally smooth. Salt and a stabilizer blend are added and chopped until the stabilizer (including, but not limited to, gums, gels and starches) is hydrated and smooth. The product (e.g., non-dairy cheese curds, cream cheese, etc.) is then placed in containers, such as cups.

FIG. 5 is a flow chart illustrating a method 500 for producing a cheese replica in accordance with another embodiment of the disclosure. At block 502, milk is pasteurized at 160° F.-195° F. and then cooled to 92° F.-98° F. At block 504, culture and coagulating agent are mixed in with gentle agitation and allowed to ferment to target pH level. At block 506, coagulum at pH 4.3-4.5 can be cut. At block 508, the coagulum can be drained to 50-68%. Additives (e.g., salt, stabilizer, flavors, herbs, spices, preservatives, etc.) can be added and mixed until well dispersed. At block 510, the product (e.g., cheese curds, ricotta curds, ricotta, etc.) is then placed in containers, such as cups.

Tables 5-8 list exemplary ingredients of cheese replicas that can be produced using the methods discussed in connection with FIGS. 4 and 5.

TABLE 5
Cream Cheese Curd (% values represent weight/weight)
Cream Cheese Curd

| Ingredient | Usage (%) |
|---|---|
| Plant-Based Solids | 17-25 |
| Plant-Based Fat | 12-18 |
| Plant-Based Protein | 4-6 |
| Coagulating Agent | <1 |
| Culture | <1 |
| Water | 50-68 |

TABLE 6
Cream Cheese Plain (% values represent weight/weight)
Cream Cheese Plain

| Ingredient | Usage (%) |
|---|---|
| Cream Cheese Curd | 86-96 |
| Salt | <2 |
| Stabilizer Blend | <1 |
| Lactic Acid | <1 |
| Water | <10 |

TABLE 7
Ricotta Curd (% values represent weight/weight)
Ricotta Curd

| Ingredient | Usage (%) |
|---|---|
| Plant Based Solids | 17-25 |
| Plant Based Fat | 12-18 |
| Plant Based Protein | 4-6 |
| Coagulating Agent | <1 |
| Culture | <1 |
| Water | 50-68 |

TABLE 8
Ricotta Plain (% values represent weight/weight)
Ricotta Plain

| Ingredient | Usage (%) |
|---|---|
| Ricotta Curd | 86-96 |
| Salt | <1 |
| Tartaric Acid | <1 |

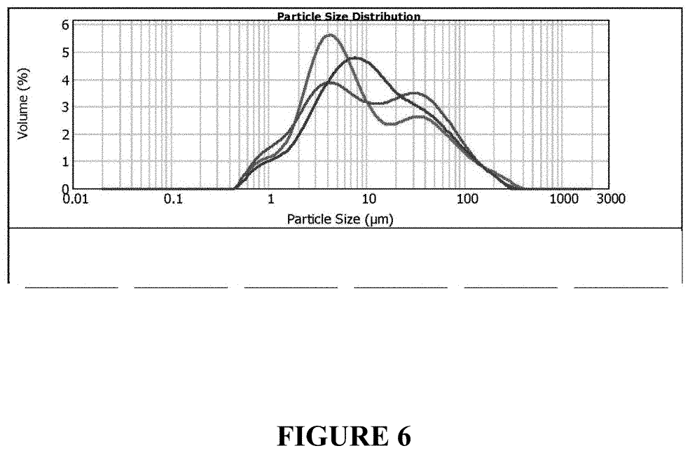

With reference to FIG. 6, a graph is provided showing particle size distributions of solid particles in various non-dairy milk made in accordance with the methods described herein. As can be seen in FIG. 6, each non-dairy milk includes solid particles in the range of from about 0.5 microns to about 400 microns, but wherein 90% of the solid particles are less than 70 microns and wherein 50% of the solid particles are less than 10 microns. These particle distributions are achieved without the removal of any solids materials during the milk make process. In some previously known non-dairy milk make processes, particle distributions such as those shown in FIG. 6 are only achieved by virtue of performing a filtration or separation step in which larger soluble and insoluble solids are removed from the slurry during the milk make process. As such, these previously known processes are less efficient and economical than the processes described herein.

The non-dairy milk produced from the methods and system described herein provide an improvement over previously known methods and systems at least because the methods and systems described herein do not utilize separation steps in which solid particles, such as soluble fibers, insoluble fibers, fats and proteins, are removed from the slurry during the milk make process. In some previously known methods, anywhere from 10 to 20 wt % of the slurry is separated during the milk make process. This removed material is generally treated as waste despite including components that would be desirable and/or beneficial for inclusion in the non-dairy milk. As such, the economics and yield of these methods are diminished as compared to the methods and systems described herein. Furthermore, despite concerns relating to diminished mouthfeel and hindered curd formation when insoluble solids are not removed from the slurry during the milk make process, the non-dairy milk produced from the methods and systems described herein do not appear to suffer from these problems. With respect to mouthfeel, use of the shearmill to reduce the size of larger insoluble and soluble particles minimizes or eliminates issues of diminished mouthfeel. With respect to hindered curd formation, the non-dairy milk produced from the methods and systems described herein do not exhibit this problem, even when insoluble solids remain in the non-dairy milk. It is theorized that reducing the size of the insoluble solids through use of the shearmill may be minimizing or eliminating any issues related to inhibited curd formation.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The embodiments, features, systems, devices, materials, compositions, methods, and techniques described herein may, in some embodiments, be similar to or include any one or more of the embodiments, features, systems, devices, reagents, processing steps, materials, methods, and techniques described in U.S. Pat. No. 9,011,949 and PCT Application No. PCT/US2012/046552, all of which are incorporated by reference in their entireties. In addition, the embodiments, features, systems, devices, materials, compositions, methods, and techniques described herein may, in certain embodiments, be applied to or used in connection with any one or more of the embodiments, features, systems, devices, materials, methods, and techniques disclosed in the above-mentioned U.S. Pat. No. 9,011,949 and PCT Application No. PCT/US2012/046552. Aspects of the disclosed embodiments can be modified, if necessary, to employ concepts of the various patents, applications, and publications to provide yet further embodiments. All applications and patents listed above are incorporated herein by reference in their entireties.

Unless otherwise indicated, all numbers and expressions, such as those expressing dimensions, physical characteristics, etc., used in the specification (other than the claims) are understood as modified in all instances by the term “approximately” or “about”. At the very least, and not as an attempt to limit the application of the doctrine of equivalents to the claims, each numerical parameter recited in the specification or claims which is modified by the term “approximately” or “about” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all subranges or individual values that are between and/or inclusive of the minimum value of 1 or more and ending with a maximum value of 10 or less (e.g., 5.5 to 10, 2.34 to 3.56, and so forth) or any value from 1 to 10 (e.g., 3, 5.8, 9.9994, and so forth).

From the foregoing, it will be appreciated that specific embodiments of the invention have been described herein for purposes of illustration, but that various modifications may be made without deviating from the scope of the invention. Accordingly, the invention is not limited except as by the appended claims.

1. A method of making non-dairy milk, comprising:
decompounding a slurry comprising nuts, seeds, or both, to produce a decompounded slurry, wherein the decompounded slurry includes an insoluble solids content; and
milling in a shearmill the decompounded slurry to produce a milled slurry, wherein the decompounded slurry subjected to milling includes substantially all of the insoluble solids content of the decompounded slurry.

2. The method of claim 1, wherein the milled slurry comprises solid particles and the milling results in 90% of the solid particles in the milled slurry having a particle size of less than about 70 microns.

3. (canceled)

4. The method of claim 2, wherein the milling results in 50% of the solid particles in the milled slurry having a particle size of less than about 10 microns.

5. (canceled)

6. The method of claim 1, wherein the milling is performed directly after the decompounding.

7. The method of claim 1, wherein the slurry comprises nuts.

8. The method of claim 7, wherein the nuts comprise almonds.

9. The method of claim 1, wherein decompounding the slurry comprises a first decompounding step and a second decompounding step.

10. The method of claim 9, wherein the first decompounding step is a first grinding step carried out in a first grinder and the second decompounding step is a second grinding step carried out in a second grinder.

11. The method of claim 10, wherein the first grinding step reduces the particle size of the nuts, seeds or both to a first average particle size, and the second grinding step reduces the particle size of the nuts, seeds or both to a second average particle size, wherein the second average particle size is smaller than the first average particle size.

12. The method of claim 1, wherein the insoluble solids content includes insoluble fibers.

13.-21. (canceled)

22. A non-dairy milk produced by a method comprising:
decompounding a slurry comprising nuts, seeds, or both, to produce a decompounded slurry; and
milling in a shearmill an unfiltered and unseparated decompounded slurry to produce a milled slurry.

23. The non-dairy milk of claim 22, wherein the milled slurry comprises solid particles and the milling results in 90% of the solid particles in the milled slurry having a particle size of less than about 65 microns.

24. (canceled)

25. (canceled)

26. The non-dairy milk of claim 23, wherein the milling results in 50% of the solid particles in the milled slurry having a particles size of less than about 7 microns.

27. The non-dairy milk of claim 22, wherein the milling is performed directly after the decompounding.

28. The non-dairy milk of claim 22, wherein the slurry comprises nuts.

29. The non-dairy milk of claim 28, wherein the nuts comprise almonds.

30. The non-dairy milk of claim 22, wherein decompounding the slurry comprises a first decompounding step and a second decompounding step.

31. The non-dairy milk of claim 30, wherein the first decompounding step is a first grinding step carried out in a first grinder and the second decompounding step is a second grinding step carried out in a second grinder.

32. The non-dairy milk of claim 31, wherein the first grinding step reduces the particle size of the nuts, seeds or both to a first average particle size, and the second grinding step reduces the particle size of the nuts, seeds or both to a second average particle size, wherein the second average particle size is smaller than the first average particle size.

33. A method of making a non-dairy product, comprising:
decompounding a slurry comprising a non-diary foodstuff to produce a volume of decompounded slurry with insoluble solids content, wherein the non-diary foodstuff includes nuts, seeds, or both;
milling the decompounded slurry to reduce the size of the insoluble solids, wherein the milled slurry includes at least 90% by weight of total weight of the non-diary foodstuff that is decompounded; and
processing the milled slurry to produce a non-dairy product.
